(19) United States
(12) Patent Application Publication
(10) Pub. No.: US 2007/0243318 A1
(43) Pub. Date: Oct. 18, 2007

(54) Method for Producing Coated Electrical Wires

(76) Inventors: Marcus Meichsner, Kamp-Lintfort (DE); Gunter Stevens, Kempen (DE)

Correspondence Address: FRIEDRICH KUEFFNER, 317 MADISON AVENUE, SUITE 910, NEW YORK, NY, 10017, US

(21) Appl. No.: 10/590,126

(22) PCT Filed: Jan. 24, 2005
(86) PCT No.: PCT/EP05/50384

§ 371 Date: Jun. 18, 2007

(30) Foreign Application Priority Data
Feb. 20, 2004 (DE) 10 2004 008 365.7

(51) Int. Cl. H01B 3/40

(52) U.S. Cl. 427/120

(57) ABSTRACT

The present invention relates to a method for producing coated electrical wires for which coating is carried out using UV-curable baking enamels which comprise a) one or more oxirane-based binders, b) one or more UV crosslinking catalysts, c) if desired, reactive diluents, d) chain transfer agents, and e) further customary additives.

The present invention relates to a method for producing coated electrical wires.

The winding carriers used for producing motors, magnetic coils, lifting magnets, and generators are frequently subject to severe mechanical loads. Particularly in the case of high-speed rotors the attendant centrifugal and centripetal forces which act on the windings of the moving components are quite considerable.

In order to prevent or at least reduce damage and deformation of the stressed apparatus components, windings are fixed at an early stage. This is done by impregnating with impregnating varnishes or impregnating resins. The impregnating varnishes or resins must be cured. This is typically accomplished by oven curing of the component at elevated temperatures over a prolonged period.

An innovation in the fixing of wires was the introduction of baking enamels, which came into their own in particular in the field of the manufacture of deflection coils in TV technology.

The principle of the baking enamels is based on the thermoplastic property, which allows the enameled wires to be bonded after the winding of the coil. The film of baking enamel, applied appropriately over an existing insulating primer of the enamel wire, is first of all melted, the interstices of the winding being partly filled with the melted thermoplastic and hence bonding the individual windings via the thermoplastic. As a result of the subsequent hardening of the polymer, all of the windings are fixed to one another, and hence deformation of the winding, which in particular in the case of self-supporting coils would cause a change in inductivity, can be prevented.

The melting of the baking enamel is accomplished thermally, on the one hand by the heat treatment of the finished components in a heating oven and on the other hand electrically as a result of current impulse.

The advantage of baking enamels in the manufacture of all kinds of coils caused the constructors to develop new apparatus for the winding technology. Nowadays baking enamels are employed virtually in all areas of enamel wire processing for fixing of windings, even where the thermal requirements are exacting.

Different classes of substance are used as a basis for baking enamels in dependence of the field of use.

EP 1 096 510 describes the use of polyvinyl acetals (PVA). The level of thermal and mechanical properties of these baking enamels is modest.

EP 0 331 823 describes polyvinyl butyrals and polyvinyl formals. Owing to a relatively high average water absorption and a relatively low softening point of the polyvinyl butyrals, these materials are not readily used.

U.S. Pat. No. 4,129,678 describes phenoxy resins, which frequently find use for moisture-sensitive and temperature-resistant applications. Additionally using phenolic resins and/or melamine resins, relatively high-viscosity baking enamels are produced, which in the course of baking can release small amounts of formaldehyde and phenol. This is one of the greatest disadvantages of these enamel formulations.

EP 0 399 396 describes polyamides for use as baking enamels. In the preparation of the polyamides, specifically for use as baking enamel binders, there are far more possibilities for variations than for the other classes of compounds. A broad range of copolyamides formed from aromatic and/or aliphatic dicarboxylic acids, aromatic and/or aliphatic diamines, and, predominantly, aromatic diisocyanates are known and are used with modification of blocked polyisocyanates where appropriate.

U.S. Pat. No. 4,131,714 describes linear polyesters which find use, as binders, in solution in appropriate solvents, as a baking enamel for wire coating.

All of the stated baking enamel systems are applied by means of conventional wet coating material application by felt stripping or nozzle application methods to enamel wires that have already been insulated, and are dried thermally, with the solvents expelled being incinerated in the catalysts of the conventional enameling lines. The softening range of the film of baking enamel which remains is regulated not uncommonly by way of the residual solvent content of the polymer, which presents the fundamental disadvantage of solvent release during baking.

DE 28 43 895 C3 relates to the curing of successive wire enamel films by means of UV light. The objective described was in particular to avoid solvents. A film with good adhesion was applied to the wire, a further film was applied as an insulating enamel, followed by a heat-resistant and also an abrasion-resistant and scratch-resistant film, with all of the films being UV-curable.

DE 29 15 011 describes the preparation and use of radiation-curable polyesterimides which are likewise applied as insulating material to copper wires. The preparation of UV-curable binders for use as baking enamels is not described.

It is an object of the present invention to provide a baking enamel which is solvent-free and can be cured by UV light.

This object is achieved by carrying out coating using UV-curable baking enamels which comprise

a) one or more oxirane-based binders,

b) one or more UV crosslinking catalysts,

c) if desired, reactive diluents,

d) if desired, chain transfer agents, and

e) further customary additives.

The baking enamels of the invention are free from solvents of any kind, with water as well counting as a solvent.

The UV-curable baking enamels described advantageously comprise:

a) 50%-95% of oxirane-based binders,

b) 1%-10% of UV crosslinking catalysts,

c) 0-80% of reactive diluents,

d) 0-40% of chain transfer agents, and

e) 1%-8% of additives, stabilizers, etc.

UV-curable baking enamels preferred in accordance with the invention comprise:

a) 60%-93% of oxirane-based binders,

b) 2%-6% of UV crosslinking catalysts,

c) 0-70% of reactive diluents,

d) 0-35% of chain transfer agents, and

e) 1%-3% of additives, stabilizers, etc.

The binders a) preferably comprise cycloaliphatic oxirane compounds of the general form 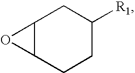
where R₁ can be a hydrogen, a carboxylate radical of the indicated form 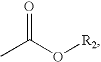
a polyether radical 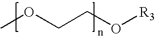
with n=1-50 or a polyester radical of the following form 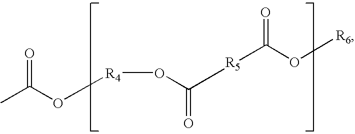
where R₂ can be a methyl, ethyl, propyl or butyl radical or a further oxirane ring or a further oxirane compound of the type 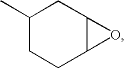
where R₃ is a hydroxyethyl radical or an oxirane compound of the following form 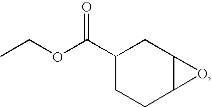
R₄ and R₅ describes an aliphatic hydrocarbon chain of 2-6 carbon units, it being possible in addition for R₅ to be a phenylene radical, and R₆ is a hydroxyalkyl radical having 2-6 carbons or an oxirane compound of the following form

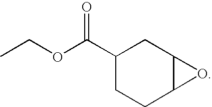

Other mono-, di-, and polyoxiranes, not described here in detail, can likewise be employed as binders.

A compound suitable for preparing baking enamels is 3,4-epoxycyclohexylmethyl 3,4-epoxycyclohexanecarboxylate, which is available under the name “Cyracure UVR 6110” from Union Carbide Corporation.

The relatively high molecular mass mono- and dioxiranes used can be prepared by reacting methyl 3,4-epoxycyclohexanecarboxylate with OH-functional polyethylene glycols or polypropylene glycols having n=1-50 ethoxy or propoxy units, respectively, preferably n=5-25, more preferably n=8-12, on the one hand, to give the polyether monooxiranes and polyether dioxiranes, or with aliphatic and/or aromatic dicarboxylic acids and polyols, to give the polyester monooxiranes and polyester dioxiranes.

Suitable aromatic dicarboxylic acids and/or dicarboxylic acid dimethyl esters are for example isophthalic acid, terephthalic acid, dimethyl terephthalate, and dimethyl naphthalenedicarboxylate. Isophthalic acid and dimethyl terephthalate are particularly preferred. Suitable aliphatic dicarboxylic acids are, for example, adipic acid, azelaic acid, and decanedicarboxylic acid, with adipic acid being particularly preferred.

Polyols used include ethylene glycol, propylene glycol, neopentyl glycol, and butane-1,4-diol. Mixtures of ethylene glycol and neopentyl glycol have proven particularly advantageous for the application described.

Suitable as UV crosslinking catalyst b) is preferably a photoinitiator, or initiator mixture, which is suitable for cationic photopolymerization. For the baking enamels of the invention it is preferred to use the mixed arylsulfonium hexafluorophosphate salt of the following form

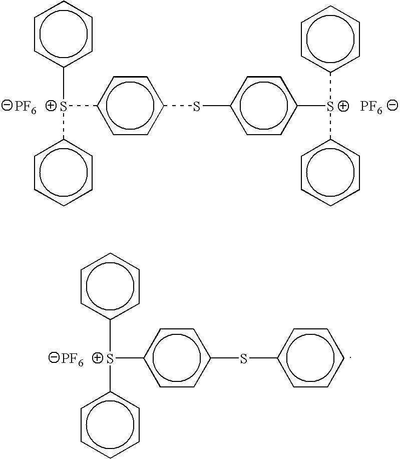

Instead of or in addition to this, component b) may also include other customary UV crosslinking catalysts.

Suitable reactive diluents c) include preferably low molecular mass oxiranes, oxetanes, and other compounds copolymerizable with the oxiranes of the invention.

As chain transfer agents d) and in order to increase the crosslinking density it is advantageous to use unbranched or branched polyester polyols having molecular weights of between 500 and 2000 g/mol, preference being given to polyester polyols having an average molecular weight of between 500 and 1000 g/mol.

As flow control additives e) it is possible with preference to use surface-active modified polydisiloxanes, such as, for example, Byk 306 from Byk Chemie GmbH.

The invention is illustrated by reference to the following examples:

### EXAMPLE 1

### Preparation of a Dioxirane from Polyethylene Glycol 400 and Methyl 3,4-Epoxycyclohexanecarboxylate (Dioxirane I)

62.4 g of methyl 3,4-epoxycyclohexanecarboxylate are mixed with 80 g of a polyethylene glycol 400, blanketed with nitrogen as inert gas, admixed with 0.2 g of tetrabutyl titanate, and finally transesterified with elimination of 12.8 g of methanol at 180-200° C. 155.4 g of a highly viscous polyethylene glycol dioxirane are obtained.

### EXAMPLE 2

### Preparation of a Dioxirane from Dimethyl Terephthalate, Ethylene Glycol, Neopentyl Glycol and Methyl 3,4-Epoxycyclohexanecarboxylate (Dioxirane II)

31.2 g of methyl 3,4-epoxycyclohexanecarboxylate are mixed with 97 g of dimethyl terephthalate, 15.5 g of ethylene glycol, and 26.0 g of neopentyl glycol, blanketed with nitrogen as inert gas, admixed with 0.2 g of tetrabutyl titanate, and finally transesterified with elimination of 38.4 g of methanol at 180-200° C. 131.5 g of a waxlike polyester dioxirane are obtained.

### EXAMPLE 3

### Preparation of a Dioxirane from Adipic Acid, Ethylene Glycol, Neopentyl Glycol and Methyl 3,4-Epoxycyclohexanecarboxylate (Dioxirane III)

31.2 g of methyl 3,4-epoxycyclohexanecarboxylate are mixed with 73 g of adipic acid, 15.5 g of ethylene glycol, and 26.0 g of neopentyl glycol, blanketed with nitrogen as inert gas, admixed with 0.2 g of tetrabutyl titanate, and finally esterified with elimination of 6.4 g of methanol and 18 g of water at 180-200° C. 121.5 g of a waxlike polyester dioxirane are obtained.

The oxiranes prepared are used to formulate UV-curable baking enamels:

### EXAMPLE 4

### Baking Enamel 1

A UV-curable enamel is prepared from 32.5 g of Cyracure UVR 6110, 30 g of dioxirane III, 5 g of photoinitiator, 30 g of methyl 3,4-epoxycyclohexanecarboxylate, and 2.5 g of flow control additive. The components are mixed homogeneously to a colorless transparent enamel, with 790 mPa s.

### EXAMPLE 5

### Baking Enamel 2

A UV-curable enamel is prepared from 52.5 g of Cyracure UVR 6110, 40 g of dioxirane I, 5 g of photoinitiator, and 2.5 g of flow control additive. The components are mixed homogeneously to a colorless transparent enamel, with 670 mPa s.

### EXAMPLE 6

### Baking Enamel 3

A UV-curable enamel is prepared from 67.5 g of Cyracure UVR 6110, 25 g of polyester polyol Desmophen 670, 5 g of photoinitiator, and 2.5 g of flow control additive. The components are mixed homogeneously to a colorless transparent enamel, with 2340 mPa s.

The baking enamels prepared in accordance with the invention were by means of a nozzle stripping method to a copper wire with a felt wire diameter of 0.30 mm, conventionally coated with a commercially customary polyesterimide wire enamel, with a total increase in diameter of 50 μm, and cured at 10-80° C. and by means of UV light. The UV source used was a microwave-excited high-pressure mercury vapor lamp. The power of the lamp was between 25 and 100 watts per cm. Reflector and lamp here form a resonator unit.

In accordance with the international standard of DIN EN 60851-3 (IEC 851-3) the tests for baking resistance were performed on coils produced in accordance with the standard. The minimum baking force required for the present wire diameter was significantly exceeded by the 0.7 N found.

The following test results were obtained:

Baking enamel 1: For an enamel film of 10 μm, an enameled wire with a smooth surface and good baking properties at 200° C. is obtained, with a baking force of 0.7 N.

Baking enamel 2: For an enamel film of 10 μm, an enameled wire with a smooth surface and good baking properties at 200° C. is obtained.

Baking enamel 3: For an enamel film of 11 μm, an enameled wire with a smooth surface and good baking properties at 200° C. is obtained, with a baking force of 0.8 N.

1. A method for producing coated electrical wires, characterized in that coating is carried out using UV-curable baking enamels which comprise
a) one or more oxirane-based binders,
b) one or more UV crosslinking catalysts,
c) if desired, reactive diluents,
d) if desired, chain transfer agents, and
e) further customary additives.

2. The method of claim 1, characterized in that baking enamels are used containing
a) 50%-95% by weight of oxirane-based binders,
b) 1%-10% by weight of UV crosslinking catalysts,
c) 0-80% by weight of reactive diluents,
d) 0-40% by weight of chain transfer agents, and
e) 1%-8% of further additives.

3. The method of either of the preceding claims, characterized in that baking enamels are used containing
a) 60%-93% by weight of oxirane-based binders,
b) 2%-6% by weight of crosslinking catalysts,
c) 0-70% by weight of reactive diluents,
d) 0-30% by weight of chain transfer agents, and
e) 1%-3% of further additives.

4. The method of any one of the present claims, characterized in that, as baking enamel, cycloaliphatic oxirane compounds are used of the general form 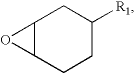
where R₁ can be a hydrogen, a carboxylate radical of the indicated form 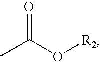
a polyether radical of the formula 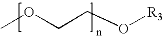
with n=1-50 or a polyester radical of the following form 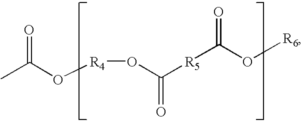
where R₂ is a methyl, ethyl, propyl or butyl radical or a further oxirane compound of the following form 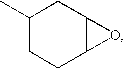
and R₃ is a hydroxyethyl radical or an oxirane compound of the following form 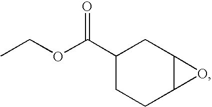
R₄ and R₅ describes an aliphatic hydrocarbon chain of 2-6 carbon units, it being possible in addition for R₅ to be a phenylene radical, and R₆ is a hydroxyalkyl radical having 2-6 carbons or an oxirane compound of the following form

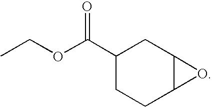

5. The method of any one of the preceding claims, characterized in that at least one photoinitiator suitable for cationic photopolymerization is added.

6. The method of claim 5, characterized in that, as a photoinitiator, a mixed arylsulfonium hexafluorophosphate salt of the following form 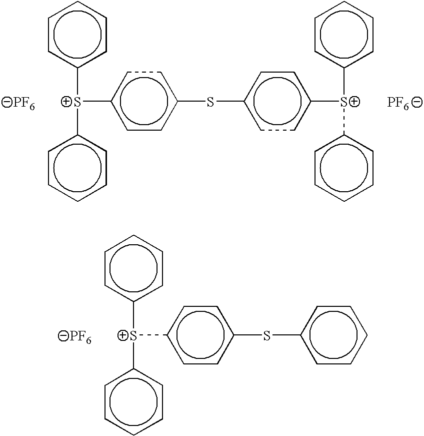
is added.

7. The method of any one of the preceding claims, characterized in that a baking enamel is used whose component a) is prepared using methyl 3,4-epoxycyclohexanecarboxylate.

8. The method of claim 7, characterized in that a baking enamel is used whose component a) has been prepared using polyethylene glycol.

9. The method of any one of the preceding claims, characterized in that baking enamels are used to which low molecular mass oxiranes, oxetanes are added as reactive diluents.

10. The method of claim 9, characterized in that low molecular mass oxiranes, oxetanes are added as reactive diluents.

11. The method of any one of the preceding claims, characterized in that component d) comprises polyester polyols having molecular weights of between 500 and 2000 g/mol.

12. The method of any one of the preceding claims, characterized in that component d) comprises polyester polyols having an average molecular weight of between 500 and 1000 g/mol.

13. The method of any one of the preceding claims, characterized in that component e) comprises additives or stabilizers or mixtures thereof.

14. The method of any one of the preceding claims, characterized in that after the electrical wire has been coated with baking enamel, said enamel is cured by means of ultraviolet radiation.
